(19) United States
(12) Patent Application Publication
(10) Pub. No.: US 2015/0199106 A1
(43) Pub. Date: Jul. 16, 2015

(54) Augmented Reality Display System

(71) Applicant: Caterpillar Inc., Peoria, IL (US)

(72) Inventor: Lonny E. Johnson, Peoria, IL (US)

(73) Assignee: Caterpillar Inc., Peoria, IL (US)

(21) Appl. No.: 14/154,327

(22) Filed: Jan. 14, 2014

(51) Int. Cl. G06F 3/0481; G06F 3/0487; G06F 3/0484

(52) U.S. Cl. CPC G06F 3/04815; G06F 3/04847; G06F 3/0487

(57) ABSTRACT

A display system for use at a work site includes a display device having a display screen and a pose sensor system. A controller determines the position and orientation of the display device relative to the work site based upon the pose sensor system, generates machine control signals to control movement of a machine without an operator at the machine controlling the movement the machine, generates an augmented reality image based upon the machine control signals and the position and orientation of the display device, and renders the augmented reality image on the display screen.

### TECHNICAL FIELD

This disclosure relates generally to an image display system and, more particularly, to a system utilizing augmented reality to inform personnel of movement of autonomously and remotely controlled machines.

### BACKGROUND

Movable machines such as haul trucks, dozers, motor graders, excavators, wheel loaders, and other types of equipment are used to perform a variety of tasks. For example, these machines may be used to move material and/or alter work surfaces at a work site. The machines may perform operations such as digging, loosening, carrying, etc., different materials at the work site.

In order to increase the efficiency of operation at a work site, movable machines are sometimes operated autonomously or semi-autonomously. In other instances, the machines are operated by remote control. In instances in which the machines are operated autonomously or by remote control, an operator will not be present on the machine. In instances of semi-autonomous operation, an operator may be present at the machine but the machine may take certain actions or make certain movements without the actions or movements being directly controlled by the operator.

Risks to personnel at work sites in which machines are operated autonomously, semi-autonomously, or by remote control may be increased as compared to work sites in which all machines are directly controlled by an operator on the machine. With respect to machines that operate autonomously or by remote control, personnel near such machines may be unaware of impending movement of the machines. For example, personnel may assume that a machine is not going to move since an operator is not present at or on the machine. With respect to machines that operate autonomously or semi-autonomously, such machines may rely on sensors to determine whether personnel are in proximity to such machines before beginning automated movement. However, unexpected movement by personnel cannot be anticipated by such sensors.

Augmented reality or augmented vision exists in which a person's perception or view of the real world is augmented with additional informational input. That input may include additional information about the scene currently viewed by the person. U.S. Patent Publication No. 2003/0014212 discloses an augmented reality system that introduces additional input to augment the perception of a surveyor who is performing surveying tasks. The augmented reality system utilizes a head-mounted apparatus and may determine the current position and direction of view of the surveyor. Based on the determined position and direction of view, the system accesses additional surveying information stored in a database and transmits the data to the head-mounted apparatus to augment the view through the apparatus. The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In an aspect, a display system for use at a work site may include a display device having a display screen and a pose sensor system associated with the display device for generating display device pose signals indicative of a position and an orientation of the display device relative to the work site. A controller may be configured to determine the position and orientation of the display device relative to the work site, generate machine control signals to control movement of a machine without an operator at the machine controlling the movement the machine, generate an augmented reality image based upon the machine control signals and the position and orientation of the display device, and render the augmented reality image on the display screen.

In another aspect, a controller-implemented method of operating a display system at a work site may include determining the position and orientation of a display device relative to the work site based upon display device pose signals generated by a pose sensor system associated with the display device and generating machine control signals to control movement of a machine without an operator at the machine controlling the movement the machine. The method may further include generating an augmented reality image based upon the machine control signals and the position and orientation of the display device and rendering the augmented reality image on the display screen.

In still another aspect, a system for use at a work site may include a machine having a propulsion system with the machine being movable without an operator at the machine controlling movement of the machine. The system may further include a display device including a display screen and a pose sensor system associated with the display device for generating display device pose signals indicative of a position and an orientation of the display device relative to the work site. A controller may be configured to determine the position and orientation of the display device relative to the work site, generate machine control signals to control movement of a machine without an operator at the machine controlling the movement the machine, generate an augmented reality image based upon the machine control signals and the position and orientation of the display device, and render the augmented reality image on the display screen.

### BRIEF DESCRIPTION OF THE DRAWINGS

FIG. 1 is a schematic view of a work site including machines and personnel performing various activities and tasks about the work site;

FIG. 2 is a diagrammatic side view of a dozer in accordance with the disclosure;

FIG. 3 is a diagrammatic perspective view of a head mountable display device;

FIG. 4 is a schematic view of heads-up display that may be associated with a machine;

FIG. 5 is a schematic view of a portable computing device illustrating the various informational inputs that may be processed by a controller and the various informational outputs from the controller to the operator display device; and

FIG. 6 is a flowchart of a process for displaying augmented reality images on a display screen of a display device.

### DETAILED DESCRIPTION

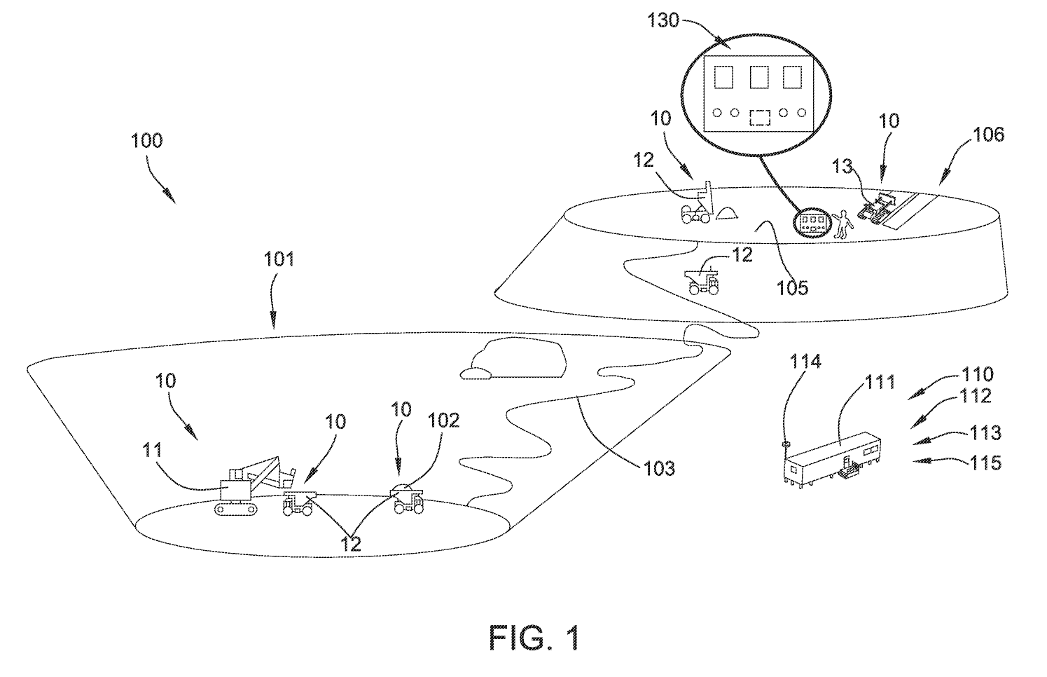

FIG. 1 depicts a diagrammatic illustration of a work site 100 at which one or more machines 10 may operate in an autonomous, a semi-autonomous, or manual manner. Work site 100 may be a portion of a mining site, a landfill, a quarry, a construction site, a roadwork site, a forest, a farm, or any other area in which movement of machines is desired. As depicted, work site 100 includes an open-cast or open pit mine 101 from which material 102 may be excavated or removed by a machine such as an excavator 11 and loaded into a machine such as a load truck 12. Various activities may be occurring simultaneously and dynamically at the work site 100. The operations being performed at the work site 100 may be conducted by various machines 10 and personnel moving about and altering the work site. For example, the load trucks 12 may travel along a road 103 to dump location 106 at which the material 102 is dumped. A machine such as a dozer 13 may move material 102 along the work surface 105 towards the dump location such as an edge of a ridge, embankment, high wall or other change in elevation. Personnel such as supervisors, surveyors, operators, engineers and the like may move about the work site 100 in machines or “on foot.”

To coordinate and potentially control the activities and movement of the machines 10 and the personnel about the work site 100, a computerized or electronically implemented management system indicated generally at 110 may be based out of a fixed or mobile location such as command center 111. The management system 110 may be implemented by a control system 112 as shown generally by an arrow in FIG. 1. The control system 112 may include an electronic control module or controller indicated generally at 113. The controller 113 may be an electronic controller that operates in a logical fashion to perform operations, execute control algorithms, store and retrieve data and other desired operations. The controller 113 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 113 such as power supply circuitry, signal conditioning circuitry, driver circuitry, and other types of circuitry.

The term “controller” is meant to be used in its broadest sense to include one or more controllers and/or microprocessors that may cooperate in controlling various functions and operations. The functionality of the controller 113 may be implemented in hardware and/or software without regard to the functionality. The controller 113 may be operatively associated with on one or more databases and/or data maps relating to the operating conditions and the operating environment of the work site 100 as well as the various machines 10 and personnel at the work site.

The control system 112 may be located at command center 111 and may also include components located remotely from the command center 111 such as on machines 10 and personnel. As such, the functionality of control system 112 may be distributed so that certain functions are performed at the command center 111 and other functions are performed remotely.

To facilitate communication between and among the command center 111, the machines 10 and the personnel, the control system 112 may include a communications system such as wireless network system 114 for transmitting signals to and from each of the command center, the machines, and the personnel. Any suitable form of communications system may be used including, for example, radio frequency (RF) signals. The communications network may be based around a central hub whereby a plurality of transceivers communicate signals to a central router that routes the signals to the intended recipient or it may be a distributed network (i.e., peer-to-peer) whereby each transceiver may communicate directly with every other transceiver.

As used herein, a machine 10 operating in an autonomous manner operates automatically based upon information received from various sensors without the need for human operator input. As an example, a haul or load truck that automatically follows a path from one location to another and dumps a load at an end point may be operating autonomously. A machine 10 operating semi-autonomously includes an operator, either within the machine or remotely, who performs some tasks or provides some input and other tasks are performed automatically and may be based upon information received from various sensors. As an example, a load truck 12 that automatically follows a path from one location to another but relies upon an operator command to dump a load may be operating semi-autonomously. In another example of a semi-autonomous operation, an operator may dump a bucket from an excavator 11 in a load truck 12 and a controller may automatically return the bucket to a position to perform another digging operation. A machine 10 being operated manually is one in which an operator is controlling all or essentially all of the functions of the machine. A machine 10 may be operated remotely by an operator (i.e., remote control) in either a manual or semi-autonomous manner.

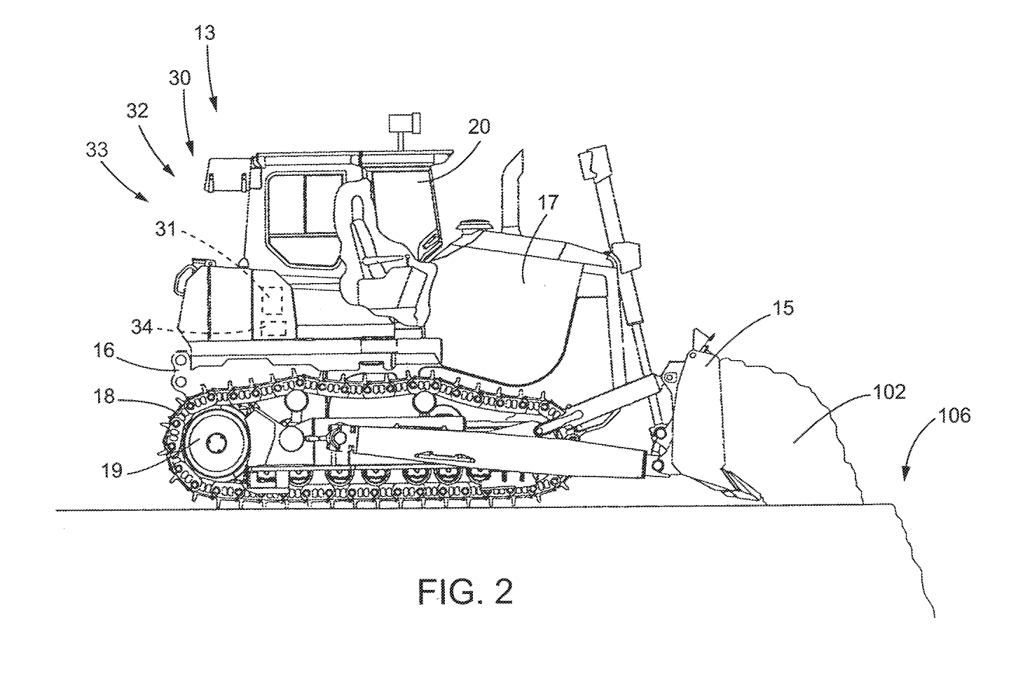

Machine 10 may be any type of machine that performs some operation associated with an industry such as mining, construction, farming, transportation, or any other industry known. For example, the machine may be an earth-moving machine, such as an excavator, wheel loader, load truck, dozer, backhoe, material handler, or any other type of working machine. FIG. 2 depicts an exemplary machine 10 such as a dozer 13 adjacent dump location 106 with a work implement or a blade 15 pushing material 102 over a crest. The machine 10 includes a frame 16 and a prime mover such as an engine 17. A ground-engaging drive mechanism such as a track 18 is driven by a drive wheel 19 on each side of machine 10 to propel the machine. Although machine 10 is shown in a “track-type” configuration, other configurations, such as a wheeled configuration, may be used. Operation of the engine 17 and a transmission (not shown) which are operatively connected to the tracks 18 and drive wheels 19 may be controlled by a machine control system 30 including a machine controller 31.

Machine 10 may include a cab 20 that an operator may physically occupy and provide input to control the machine. Cab 20 may include one or more input devices through which the operator issues commands to control the propulsion and steering of the machine as well as operate various implements associated with the machine.

Machine 10 may be equipped with a plurality of machine sensors 32, as shown generally by an arrow in FIG. 2 indicating association with the machine 10 that provide data indicative (directly or indirectly) of various operating parameters of the machine. The term “sensor” is meant to be used in its broadest sense to include one or more sensors and related components that may be associated with the machine 10 and that may cooperate to sense various functions, operations, and operating characteristics of the machine.

A position sensing system 33, as shown generally by an arrow in FIG. 2 indicating association with the machine 10, may include a position sensor 34 to sense a position of the machine relative to the work site 100. The position sensor 34 may include a plurality of individual sensors that cooperate to provide signals to machine controller 31 to indicate the position of the machine 10. In one example, the position sensor 34 may include one or more sensors that interact with a positioning system such as a global positioning system (“GPS”) to operate as a GPS sensor. The machine controller 31 may determine the position of the machine 10 within work site 100 as well as the orientation of the machine such as its heading, pitch and roll. The position and orientation of the machine 10 may sometimes be referred to as the pose of the machine. In other examples, the position sensor 34 may be an odometer or another wheel rotation sensing sensor, a perception based system, or may use other systems such as lasers, sonar, or radar to determine the position of machine 10.

Machine 10 may be controlled by a machine control system 30 as shown generally by an arrow in FIG. 2 indicating association with the machine 10. The machine control system 30 may include an electronic control module or machine controller 31. As stated above, machine control system 30 may be a component of control system 112 and machine controller 31 may be a component of controller 113. Further, machine control system 30 may have wireless communications capabilities such as a transceiver to communicate with management system 110 or other aspects of control system 112.

The machine controller 31 may receive input command signals from control system 112, remote control input command signals from an operator using a remote control console 130 (FIG. 1) to operate machine 10 remotely, or operator input command signals from an operator operating the machine 10 from within cab 20. The machine controller 31 may control the operation of various aspects of the machine 10 including the drivetrain as well as the hydraulic systems and other systems that operate the blade 15. The machine control system 30 may utilize various input devices to control the machine 10 and one or more machine sensors 32 to provide data and input signals representative of various operating parameters of the machine 10 and the environment of the work site 100. The machine control system 30 may further communicate data from the sensors including the position sensor 34 to the management system 110. For example, the machine control system 30 may periodically communicate to the management system the position of the machine 10 as well as its heading and direction and speed of travel.

To increase safety and efficiency, personnel at work site 100 may be equipped with a display system including a display device to display virtual text and/or images that are displayed to augment the image seen by the personnel. Such augmented image system is sometimes referred to as augmented reality system or augmented vision system.

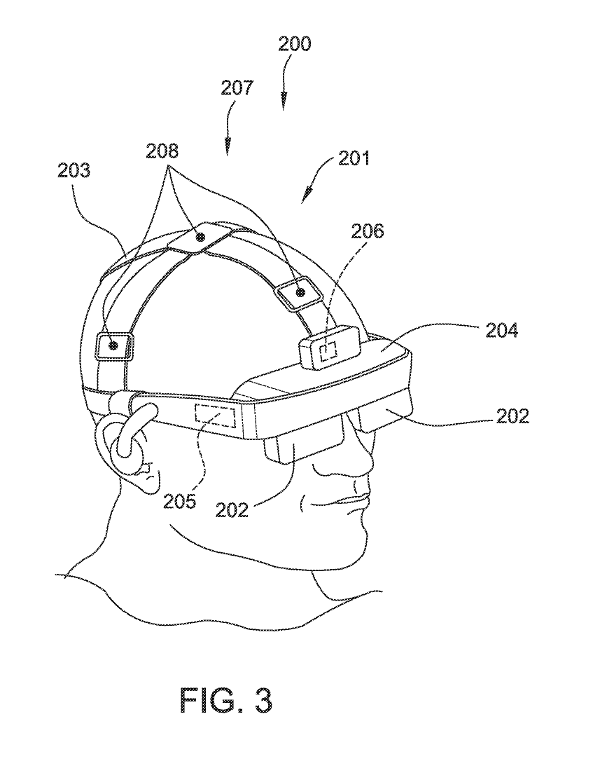

Referring to FIG. 3, in one example, a wearable augmented reality system such as a head mountable display device 201 may be used that is part of a head mountable display system 200. The head mountable display device 201 is configured to display an image or virtual objects (e.g., graphical media content such as text, images, and/or video) on a substantially transparent display screen 202. The transparency of the display screen 202 permits the wearer to maintain a view the physical environment while also viewing the virtual text and/or images that are displayed over their physical field of vision to augment the image seen by the wearer.

Head mountable display device 201 may include an adjustable strap or harness 203 that allows the head mountable display system to be worn about the head of the wearer. The head mountable display system 200 may include a visor or goggles 204 with transparent lenses that function as the display screen 202 through which the wearer views the physical environment. One or more image projectors 205 may direct images onto the display screen 202 within the wearer's line of sight.

The image projector 205 may be an optical projection system, light emitting diode package, optical fibers, or other suitable projector for transmitting an image. The display screen 202 may be configured to reflect the image from the image projector 205, for example, by a thin film coating, tinting, polarization or the like. The display screen 202 also may be a beam splitter, as will be familiar to those of skill in the art. Thus, while the display screen 202 may be transparent to most wavelengths of light, it reflects selected wavelengths such as monochromatic light back to the eyes of the wearer. Such a device is sometimes referred to as an “optical combiner” because it combines two images, the real world physical environment and the image from the image projector 205. In still other embodiments, it may be possible to configure the image projector (such a laser or light emitting diode) to draw a raster display directly onto the retina of one or more of the user's eyes rather than projecting an image onto the display screen 202. Other configurations are contemplated. Regardless of the type of image projector 205, the projected images appear as an overlay superimposed on the view of the physical environment thereby augmenting the perceived environment.

A headset controller 206 may be provided on head mountable display device 201. The headset controller 206 may have wireless communications capabilities such as a transceiver to communicate with management system 110 or other aspects of control system 112 remote from the headset controller 206 such as machine controller 31. Headset controller 206 may operate independently or with other the controllers to control the projection of the images onto the display screen 202 and determine the images to be projected by the image projector 205.

The head mountable display system 200 may also include a headset pose system 207 used to determine the orientation and position or pose of the head of the wearer. For example, the headset pose system 207 may include a plurality of headset pose sensors 208 that generate signals that may be used to determine the pose of the wearer's head. In one example, the headset pose sensors 208 may be Hall effect sensors that utilize the variable relative positions of a transducer and a magnetic field to deduce the direction, pitch, yaw and roll of the wearer's head. In another example, the headset pose sensors 208 may interact with a positioning system such as a global navigation satellite system or a global positioning system to determine the pose of the wearer's head. The data obtained by the headset pose sensors 208 may be used to determine the specific orientation of the wearer's field of view relative to the work site 100.

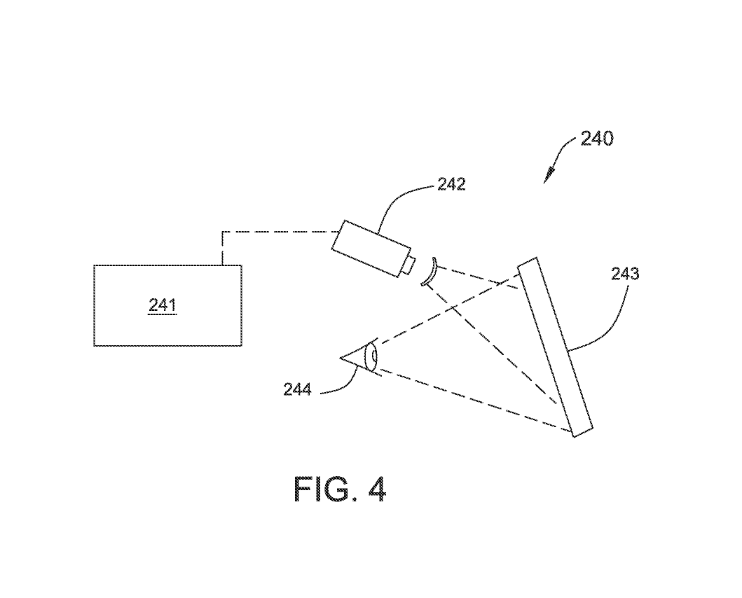

In another example of an augmented reality system, a heads-up display system 240 (FIG. 4) may be mounted on a machine 10. The heads-up display system 240 may be configured and operate in a manner somewhat similar to head mountable display system 200. Heads-up display system 240 may include a heads-up display controller 241 that controls one or more heads-up display image projectors 242. The heads-up display image projector 242 may display augmented reality text or images on a substantially transparent display screen such as the windshield 243 of the machine 10 through which the operator typically views the work site 100. As such, the display screen may be disposed in the operator's line of site as indicated by the schematic illustration of an eye at 244. The transparency of the windshield 243 permits the machine operator to maintain a view the physical environment while also viewing the virtual text and/or images that are displayed over their physical field of vision to augment the image seen by the operator. In operation, a first machine may be autonomously or semi-autonomously operated or remotely controlled and a second machine may have the heads-up display system 240 mounted thereon.

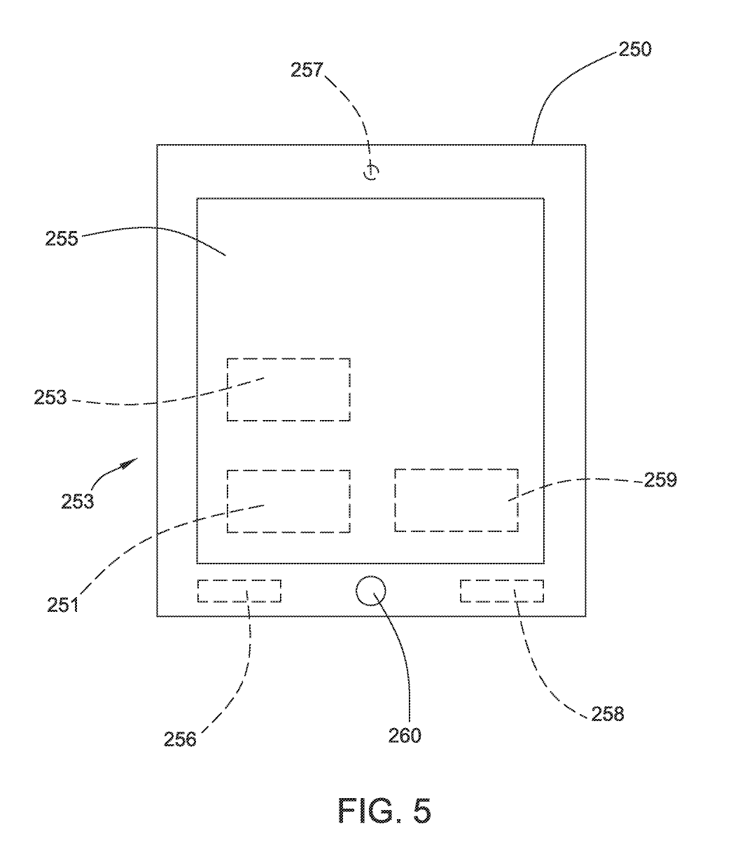

In still another example of an augmented reality system, personnel at work site 100 may be equipped with a portable computing device 250 depicted schematically in FIG. 5. Such portable computing device 250 may interact with management system 110 to increase the safety and efficiency of personnel and operations. The portable computing device 250 may include a central processing unit 251, a data storage system 252 such as memory and/or a secondary storage device, and other components for running an application. The central processing unit 251, the data storage system 252, and other aspects of the portable computing device 250 may act as a portable device controller 253 that interacts with controller 113 as a component of the control system 112.

The portable computing device 250 may also include a display screen 255, a wireless communications interface 256, a camera 257, a microphone 258, a global positioning sensor 259, and one or more input devices 260. In some instances, the display screen 255 may be configured as a touch screen to also operate as a portable device input. The wireless communications interface 256 may act as a communications channel between the control system 112 and the portable computing device 250 as well as between the portable computing device and any other system.

Central processing unit 251 may utilize data from the global positioning sensor 259 to determine the position of the portable computing device and communicate the position to the management system 110 and such position may be stored within a virtual work site map in the controller 113. In addition, the portable computing device 250 may display camera images from the camera 257 on display screen 255 and overlay augmented reality images on the camera images. In such case, a use of the portable computing device 250 may view the physical environment at which the portable computing device is directed while also viewing the virtual text and/or images that are displayed over the images on the display screen 255.

Management system 110 may maintain a virtual map of the work site 100 and each machine 10 and the personnel in controller 113 based upon position information communicated wirelessly from each machine and person back to the management system. Using the positioning and possibly other work site information, the management system 110 may generate and relay various instructions to the various machines 10 and/or personnel at the work site 100. The instructions may include any suitable information helpful to the development of the work site 100, such as coordination instructions that may direct the machines 10 and personnel where to move or travel or what activity to perform. Further, because management system 110 may concurrently track the positions and movement of all the machines 10 and personnel about the work site 100, the coordination instructions may direct or suggest interaction between the machines and/or personnel.

The management system 110 may also include information about operations being performed by the machines 10. This operational information may be particularly useful when operations are occurring that have limited or no real-time direct human control. For example, machines 10 that are being autonomously or semi-autonomously may start moving with little or no warning to nearby personnel. Still further, machines 10 that are being operated by remote control undergo similar unexpected movement with little or no warning to such nearby personnel. Accordingly, management system 110 may include an augmented reality display system, generally indicated at 115, configured to warn nearby personnel of impending or ongoing movement of various machines 10. For movements that are autonomous or semi-autonomous, a certain number of movements may be planned ahead of time. Accordingly, the augmented reality display system may generate and display an augmented reality image that includes a visual representation of such future scheduled or planned machine actions. These action may include moving the machine 10 in a specific direction at the work site 100 or moving a machine implement (e.g., a bucket of an excavator in a specific manner.

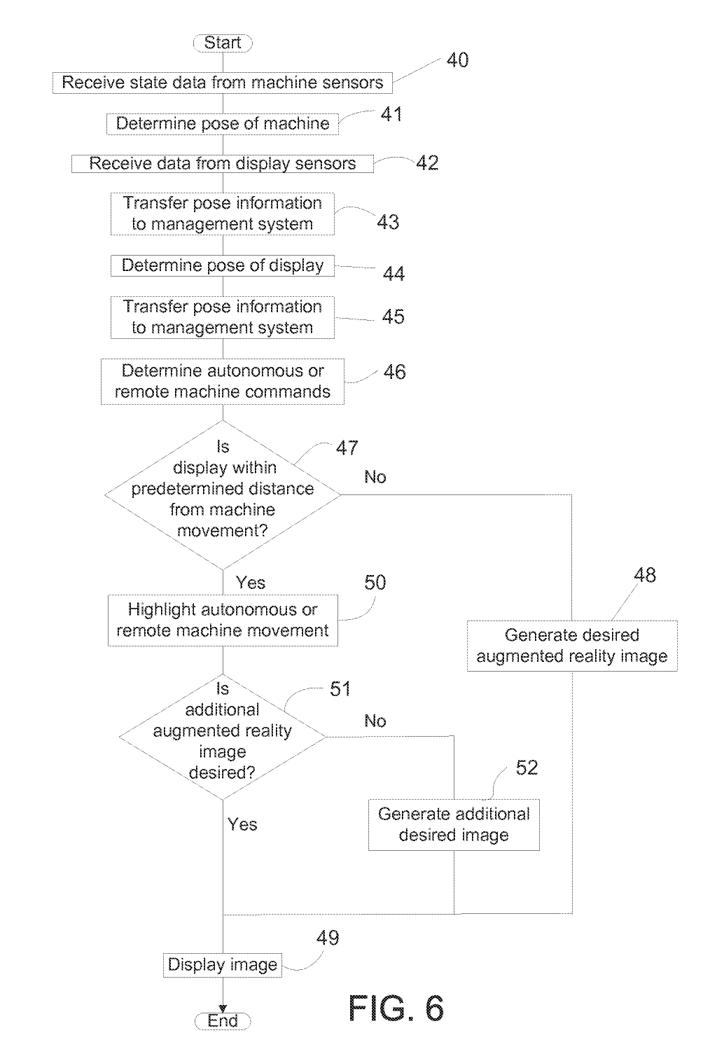

Referring to FIG. 6, a flowchart of the operation of the augmented reality display system 115 is depicted. During the operation of machines 10, the machine controller 31 of each machine 10 may receive at stage 40 state data from the various machine sensors 32 associated with the machine 10. The state data may include various types of data including pose data such as the position and orientation of the machine. At stage 41, machine controller 31 may use the state data in the form of position data from the position sensor 34 to determine the pose or position and orientation of the machine 10. The machine controller 31 may communicate at stage 42 the pose of the machine 10 to the management system 110. The process may be repeated for each machine 10 and the data stored within controller 113 as part of a virtual map of the work site 100.

At stage 43, data may be generated by the sensors of the display device such as the headset pose sensors 208 of head mountable display device 201 and received by headset controller 206. The data may be used at stage 44 to determine the pose of the display screen, which corresponds to the pose of the wearer's head, relative to the work site 100. The headset controller 206 may communicate at stage 45 the pose of the head mountable display device 201 to the management system 110.

In an example in which the display device is a part of a heads-up display system 240 mounted on a machine 10, the pose of the display screen may be determined by data from the position or pose sensors of the machine 10 and data maps of the physical dimensions or configuration of the machine that correlate the pose of the machine to the position of windshield 243. In an example in which the display device is part of a portable computing device, the pose of the display screen may be determined from the global positioning sensor 259.

Controller 113 may determine at stage 46 whether any machines 10 at the work site 100 are being operated in an autonomous or semi-autonomous manner or are being operated by remote control. For example, if machines 10 are operated autonomously or semi-autonomously, the operations being performed may be controlled by management system 110 through controller 113. In case the on-board machine controller 31 is controlling the autonomous or semi-autonomous operation, the machine controller 31 may communicate the commands utilized for the autonomous or semi-autonomous operation back to the management system 110 through controller 113. Still further, if the machine 10 is being operated by remote control, the remote control signals may be sent from the remote control console 130 through management system 110 and controller 113 to machine controller 31 or, if the remote control signals are sent from the remote control console 130 directly to the machine controller 31, the remote control signals may also or simultaneously be sent to the management system 110 through controller 113. Through these processes, the management system 110 may monitor the control and operation of the various machines 10 operating in an autonomous or semi-autonomous manner or by remote control.

At decision stage 47, the controller 113 may determine whether the display device, and thus a person using the display device, is within a predetermined distance from any of the machines 10 that are being operated at the work site 100 in an autonomous or semi-autonomous manner or by remote control. The predetermined distance may be dependent upon any of a number of factors. For example, the predetermined distance may be changed based upon the type of machine 10 being operated, the type of operation being performed, or the type of display device. In other words, the predetermined distance may vary depending on each of these factors. Controller 113 may contain a data map of predetermined distances that takes into consideration each of a plurality of factors. In one example, the predetermined distance may be relatively large when associated with a machine 10 that is stationary and is about to begin movement since a user of the display device may not have any other notice of the impending movement of the machine. In instances in which a machine 10 is already in motion, continued movement of an autonomously or semi-autonomously operated or a remotely controlled machine may require a smaller predetermined distance.

If the display device is not within the predetermined distance at decision stage 47, the controller 113 may generate at stage 48 any desired augmented reality image including no image. For example, the augmented reality image may identify certain objects at the work site 100 such as with highlighting and may further specify the distance to such objects. At stage 49, the controller 113 (whether at the command center 111, at a machine 10, or at a display device) may render or display the image on the display screen.

If the display device is within the predetermined distance at decision stage 47, the controller 113 may generate at stage 50 an image to highlight the movement of the autonomously or semi-autonomously operated or remotely controlled machine. In one example, the augmented reality image may include highlighting the machine in a flashing manner. In another example, the augmented reality image may depict the future or scheduled movement of the machine 10 or an implement of the machine. If the machine 10 is not within the field of view of the display device, the display device may generate another type of image to warn the user of the display device.

At decision stage 51, the controller 113 may determine whether any other images are to be displayed on the display screen of the display device. If additional images are desired as part of the augmented reality image or overlay, the additional images may be generated at stage 52 by controller 113 and then rendered or displayed at stage 49 on the display screen together with the image generated at stage 50. If no additional images are desired, the controller 113 may render or display on the display screen at stage 49 the augmented reality image generated at stage 50.

### INDUSTRIAL APPLICABILITY

The industrial applicability of the system described herein will be readily appreciated from the foregoing discussion. The foregoing discussion is applicable to systems operating at work sites 100 in which personnel are present and machines 10 are being operated in an autonomous or semi-autonomous manner or by remote control. The display system 200 may be used at a mining site, a landfill, a quarry, a construction site, a roadwork site, a forest, a farm, or any other area in which it is desired to improve the efficiency and visibility of a machine operator.

In one embodiment, the display system includes a display device such as head mountable display device 201 having a display screen 202 and a headset pose system 207 associated with the display screen. The headset pose system 207 generates pose signals indicative of the position and orientation of the display screen relative to the work site 100. A controller 113 may be configured to generate machine control signals to control movement of a machine 10 without an operator at the machine directly controlling the movement of the machine. In some instances, the machine 10 may be an autonomously operated machine. In other instances, the machine 10 may be operated by remote control. In both of those cases, the machine will not have an operator on the machine 10. A machine 10 being operated autonomously has machine control signals generated directly by a controller such as controller 113 at command center 111 or a machine controller 31 located on the machine. A machine 10 being operated by remote control has machine control signals generated by an operator but those signals are then processed and transmitted to the remote machine. In still other instances, the machine 10 may be operated semi-autonomously. In such case, an operator is at the machine but certain actions or movements of the machine occur without the operator controlling those movements.

The controller 113 may subsequently generate an augmented reality images based upon the machine control signals and render the augmented reality image on the display screen 202. The augmented reality image may be a warning or other notification of impending or current movement of a machine 10. The augmented reality image may include a visual representation of the next scheduled or planned machine action (such as moving the machine in a specific direction or moving the machine implement in a specific manner) that the autonomous or semi-autonomous machine is being commanded to execute.

The display system provides a system to increase the safety of personnel at a work site. This may be accomplished by enhancing the awareness of the personnel of machines that are operating in an autonomous or semi-autonomous machine or a machine being operated by remote control. An augmented reality image or overlay may be displayed on a display screen associated with people at the work site to inform or alert them of impending or ongoing movements of such machines 10.

It will be appreciated that the foregoing description provides examples of the disclosed system and technique. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A display system for use at a work site, comprising:
a display device including a display screen;
a pose sensor system associated with the display device for generating display device pose signals indicative of a position and an orientation of the display device relative to the work site; and
a controller configured to:
determine the position and orientation of the display device relative to the work site;
generate machine control signals to control movement of a machine without an operator at the machine controlling the movement the machine;
generate an augmented reality image based upon the machine control signals and the position and orientation of the display device; and
render the augmented reality image on the display screen.

2. The display system of claim 1, wherein the machine is being operated without an operator on the machine.

3. The display system of claim 1, wherein the controller generates the machine control signals remotely from the machine and transmits the machine control signals to the machine.

4. The display system of claim 1, wherein the controller is further configured to generate the machine control signals autonomously to autonomously control movement of the machine.

5. The display system of claim 1, wherein the controller is further configured to generate the machine control signals to control movement of the machine based upon signals provide by an operator located remotely from the machine.

6. The display system of claim 1, wherein the display device is a head mountable display device configured to be mounted on a user's head.

7. The display system of claim 6, wherein the head mountable display device includes a transparent display screen on which the augmented reality image is displayed.

8. The display system of claim 1, wherein the display device is a portable computing device.

9. The display system of claim 8, wherein the controller is further configured to display visual images including images of the work site.

10. The display system of claim 1, wherein the display device is heads-up display device mounted on a second machine remote from the machine.

11. The display system of claim 1, wherein the controller is further configured to generate the augmented reality image based upon proximity of the display device to the machine.

12. The display system of claim 1, wherein the controller further includes a virtual work site map representing the work site, the virtual work site map including work site information, and generate the augmented reality image further based upon the work site information.

13. A controller-implemented method of operating a display system at a work site, comprising:
determining a position and an orientation of a display device relative to the work site based upon display device pose signals generated by a pose sensor system associated with the display device;
generating machine control signals to control movement of a machine without an operator at the machine controlling the movement the machine;
generating an augmented reality image based upon the machine control signals and the position and orientation of the display device; and
rendering the augmented reality image on a display screen of the display device.

14. The method of claim 13, further including operating the machine without an operator on the machine.

15. The method of claim 1, further including generating the machine control signals remotely from the machine and transmitting the machine control signals to the machine.

16. The method of claim 13, further including generating the machine control signals autonomously to autonomously control movement of the machine.

17. The method of claim 13, further including an operator located remotely from the machine generating the machine control signals to remotely control movement of the machine.

18. The method of claim 13, further including displaying the augmented reality image on a transparent display.

19. The method of claim 13, further including generating the augmented reality image based upon proximity of the display device to the machine.

20. A system for use at a work site, comprising:
a machine having a propulsion system, the machine being movable without an operator at the machine controlling movement of the machine;
a display device including a display screen;
a pose sensor system associated with the display device for generating display device pose signals indicative of a position and an orientation of the display device relative to the work site; and
a controller configured to:
determine the position and orientation of the display device relative to the work site;
generate machine control signals to control the movement of the machine;
generate an augmented reality image based upon the machine control signals and the position and orientation of the display device; and
render the augmented reality image on the display screen.
